(19) United States
(12) Patent Application Publication
(10) Pub. No.: US 2007/0022198 A1
(43) Pub. Date: Jan. 25, 2007

(54) Method and system for pushing asynchronous notifications to networked devices

(75) Inventors: Alan Messer, Los Gatos, CA (US); John W. Chaney, Gilroy, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/185,201

(22) Filed: Jul. 19, 2005

(51) Int. Cl. G06F 15/16

(52) U.S. Cl. 709/227

(57) ABSTRACT

A method and system for pushing asynchronous notifications to devices in a network including client devices and server devices. A connection is established between a client device and a server device, wherein the client device sends a request for data to the server device, the server device includes a notification tag in a reply to the request from the client device for the client device to maintain the connection to the server device to await notifications from the server device, the client device receives the reply from the server device and checks for a notification tag in the reply such that if the reply includes a notification tag the client device maintains the connection to the server device to send notifications to the client device via the connection.

### FIELD OF THE INVENTION

The present invention relates to pushing asynchronous notifications to networked devices, and in particular to pushing asynchronous notifications to home network devices using world wide web technologies.

### BACKGROUND OF THE INVENTION

Many electronic devices, for example home network devices, include support for Web browsers supporting the HTTP and HTML standards to display and render content from one device to another. Notifications may be sent from server devices to client devices for a number of reasons, including: alert messages, device status updates for general communication, etc. Some home network middleware systems, such as UPNP, HAVI, Jini, etc. use an explicit eventing mechanism to send these updates to a programmatic client device for interpretation.

Typically, the notifications are sent out-of-band using a separate communication channel between the server device and the client device. For example, UPNP uses the GENA eventing mechanism. These systems however, require the client device to be able to understand the purpose of the events and produce an appropriate action to match those events. But, for notification to the user, it is the source of the events that actually has an understanding of what the event should produce on the client device.

Further, general Web technologies, such as HTTP, pull data from a source (e.g., server device) rather than push data to a client device. Some conventional systems attempt to alleviate this process by allowing content to be pushed from the server device to the client device. This allows Web pages to be pushed down the same connection to a browser enabled client device (e.g., desktop computer, TV, etc.) to update the Web page content thereon. However, this approach only focuses on updating web content in the client device domain and does not lend itself to general notifications.

Other solutions attempt to improve performance on Web traffic by causing a browser to keep a connection open to a web server to allow it to receive another page without re-establishing a TCP connection (TCP/IP) with the server. This reduces connection and page delivery latency but does not address pushing general notifications to the client devices. This is the persistent connection method of HTTP1.1, in which the client always leaves the connection open ended and then can receive HTML content that refreshes previously written content or sends new information to be rendered. This is expensive in that the client must always be prepared for such extra data.

As such, there is a need for a method and system that allows sending asynchronous notifications to client devices without using a separate channel for standardized events that must be interpreted by the client devices.

### BRIEF SUMMARY OF THE INVENTION

The present invention addresses the above needs. In one embodiment the present invention provides a method of pushing asynchronous notifications to devices in a network including client devices and server devices, comprising the steps of: establishing a connection between a client device and a server device; the client device sending a request for data to the server device; the server device including a notification tag in a reply to the request from the client device for the client device to maintain the connection to the server device to await notifications from the server device; the client device receiving the reply from the server device; the client device checking for a notification tag in the reply, and if the reply includes a notification tag, the client device maintaining the connection to the server device for notifications; and the server device notifying the client device that an event has occurred.

The method can further comprise the steps of the server device including data requested by the client device in the reply, and the client device receiving the requested data in the reply from the server device and displaying the requested data on a display. After sending a notification to the client device, the server device can automatically send new data to the client device via that connection or close connection.

The notification from the server device can further include a request for a response from the client device, such that the client device can send a response to the client device. Based on the response from the client device, the server device can take different steps. For example, the server device can remove the notification from the client device such that the client device closes the connection. Alternatively, the server device can update the notification to the client device via the connection. Further, the server device can send a new notification to the client device via the connection.

In another embodiment the present invention provides a system for pushing asynchronous notifications to electronic devices, comprising: a client device and a server device, such that a connection can be established from the client device to a server device; the client device and the server device are configured such that: the client device sends a request for data to the server device; upon receiving the request, the server device includes a notification tag in a reply to the request for the client device to maintain the connection to the server device to await notifications from the server device; and upon receiving the reply, the client device checks for a notification tag in the reply, and if the reply includes a notification tag, the client device maintains the connection to the server device for notifications such that thereafter the server device can send event notifications to the client device via the connection.

The present invention allows the server devices to send notifications to the client devices with much less complexity (e.g., no interpretation code is needed at the client device), enables the server devices to control how the client devices displays events, etc. An example method in this invention allows the client to know situations a priori in which extra data may arrive thereby limiting the need to maintain connections.

Other embodiments, features and advantages of the present invention will be apparent from the following specification taken in conjunction with the following drawings.

### BRIEF DESCRIPTION OF THE DRAWINGS

FIG. 1 shows an example functional block diagram of a network implementing an asynchronous notification method according to an embodiment of the present invention;

FIG. 2 shows an example system for sending asynchronous notification between client devices and server devices according to an embodiment of the present invention; and

FIG. 3 shows an example flowchart of the steps of asynchronous notification method between a client device and a server device in FIG. 2.

### DETAILED DESCRIPTION OF THE INVENTION

Many electronic devices, for example home network devices, include support for Web browsers supporting the HTTP and HTML standards to display and render content from one device to another. Notifications may be sent from servers to client devices for a number of reasons, including: alert messages, device status updates for general communication, etc. Typically, the notifications are sent out-of-band using a separate communication channel between the server and the client device. Though the source of the events has an understanding of what the event should produce on the client device, conventional systems require the client device to understand the purpose of the events and produce an appropriate action to match those events.

To address such shortcomings, in one example embodiment, the present invention provides a method and system for sending asynchronous notifications to client devices using web technologies such as HTTP. Rather than using a separate channel for standardized events that must be interpreted by the client device, a server is able to send event notifications for direct display on the client device.

In one example, this allows the server device to send notifications to the client device with much less complexity (e.g., no interpretation code is needed at the client device), enables the server device to control how the client device displays events, etc. In another embodiment, the present invention provides a method and system using web content push technology to send notifications, such as alerts and status updates to computers, such as embedded devices while limiting the number of connections to maintain.

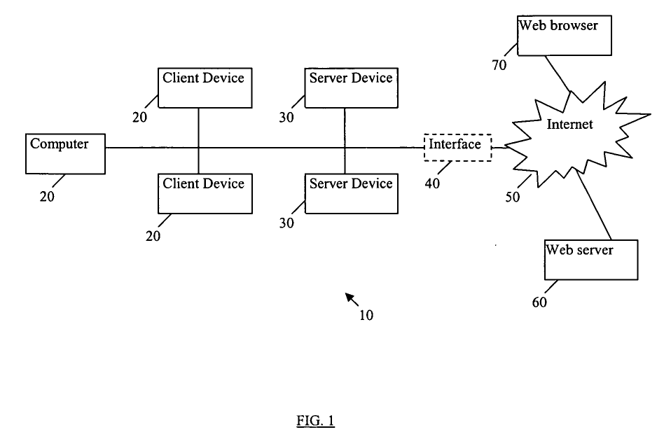

FIG. 1 shows an example functional architecture of a network 10, such as a home network, that implements an asynchronous notification method an embodiment of the present invention. The network 10 comprises client devices 20, server devices 30, and optional interface 40 that connects the network 10 to the Internet 50, the web server 60 and the web browser 70. The client and server devices 20 and 30, respectively, implement the HTTP protocol for communication and protocol therebetween. Though in the example described herein the HTTP protocol is utilized by the network 10, those skilled in the art will recognize that the present invention is useful with other network communication protocols (e.g., UDP or TCP connections, 1394 connection, etc.) that utilize client-server networking.

For example, a client device 20 can include a Web browser and a server device 30 can include a Web server. The client and server devices 20 and 30, respectively, communicate via the HTTP TCP/IP network protocol. An example client device 20 can be a TV, DVD, computer, etc. Further, an example server device 30 can be a TV, DVD, computer, etc.

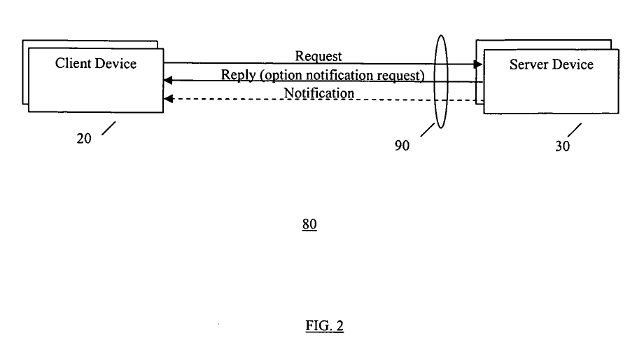

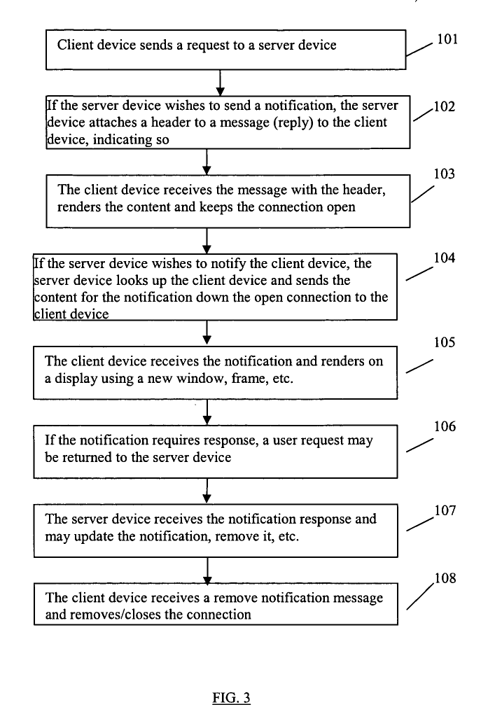

FIG. 2 shows an example system 80 that implements asynchronous notification between client devices 20 and server devices 30 via connection 90, according to an embodiment of the present invention. Further, FIG. 3 shows an example flowchart of the steps of asynchronous notification method between the client device 20 and the server device 30 in FIG. 2.

As shown in FIG. 3, in step 101, a user request is made for content from the client device 20 (e.g., computer, TV, etc.) to the server device 30 (e.g., computer, DVD, etc.) via a connection (channel) between the client device 20 and the server device 30. In step 102, if the server device 30 wishes to send a notification at a later time to the client device 20, the server device 30 adds a tag (e.g., notification header) to one of the content messages to be sent to the client device 20, to request the client device 20 to keep the connection to the server device 30 open and await new Web traffic from the server device 30 for notifications.

In step 103, the client device 20 receives a message from the server device 30 and renders it on the client device's display. In step 103, if the particular message contains a notification header, the client device 20 does not close the connection after the user's request, but leaves that connection open for notifications. Other web content, not associated with the notifications, can still be requested by the client device 20 from the server device 30 and these can be rendered on the client device 20 while the notification is pending.

There are several ways of achieving such a process. In one example, the client sets up a frame to which the server will post the notification, which could just as well be an iframe or a new window. Also, the client can just put the notification text in the middle of the screen and refresh the content once the notification was dismissed by timeout or by the user. Another example involves use of frames for various parts of the content. In that case, one frame may remain in the client device's browser (on or off-screen) to which the notification connection from the server device is still open. Frames provide an area of screen that is disjoint from other ongoing contexts and in which a new context may be established.

In step 104, the server device 30 wishes to notify the client device 20 that an event has occurred. The server device 30 looks up the client device 20 to determine which connection is being maintained by the client device 20 to await notifications from the server device 30. The server device 30 can then automatically send new web content down that connection to the client device 20. A typical embodiment can use Web push content technologies, such as sending the content as a MIME attachment or as a separate web page demarked by <HTML>/</HTML> markup. This is the context in which the client always uses the persistent connection defined in HTTP 1.1, and where the client is always attentive to new input from the server.

In step 105, the client device 20 receives new data on one of its connections from a server device 30. The client device 20 renders the new data (e.g., content) on its display (or sends it to be displayed on another device in the network 10 of FIG. 1 that is capable of displaying the content). In the example framed based approach described herein, the new content may resize the existing frame to cater for new content. Alternatively, it may switch displays or create a new window for the new notification.

In step 106, if the notification requires a response, the user clicks on a rendered display element (whether inside the notification or not. This is where the server has previously sent data that asks the user to respond by selecting an “OK” button on screen. The client device sends a request to the server device 30 of the notification. The button selected would be linked, thus generating the new request to the server. Depending on the response, in step 106, the server device 30 may choose, for example, to remove the notification (replacing it with the original content), update (e.g., repeat) the notification, place a new notification to the client device 30 via the connection, etc.

At a later time, in step 107, the server device 30 may return a notification or content that has a ‘remove notification channel’ request. This causes the client device 20 to close the connection in step 108, once received and ended notification until a user request causes a new notification channel to be requested from the client device 20 by the server device 30. The ‘remove notification channel’ request is implemented similar to the notification request in that it is indicated in the reply header from the server.

Accordingly, the server device 30 is able to send notifications to the client device 20, without special processing software on the client device 20, using existing standardized web technologies and without a separate channel for events. Further, the server 30 is able to control the presentation of content without delay for the client device 20 to poll the server device 20 for an update.

As those skilled in the art will recognize, the present invention can be used in home consumer electronics, desktop environments, embedded environments, etc. Further, non-web display technologies such as Virtual Network Computing (VNC) may also be utilized as long as there is a way of signaling the notification requirement from the server device 30 to the client device 20. Further, the client device 20 can include a Web server and the server device 30 can include a Web browser.

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspects of the invention to the embodiments illustrated. The aforementioned example architectures in FIGS. 1-3, according to the present invention, can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of pushing asynchronous notifications to devices in a network, comprising the steps of:
(a) establishing a connection with one of the devices;
(b) receiving a request for data from the device;
(c) sending a reply to the device in response to the request, wherein the reply includes a notification tag for the device to maintain the connection to await notifications; and
(d) notifying the device when an event has occurred.

2. The method of claim 1 wherein step (c) further includes the steps of including data requested by the device in the reply.

3. The method of claim 1 further including the steps of:
(e) sending new data to the device via another connection to the device.

4. The method of claim 1 further including the steps of:
(e) sending new data to the device via the connection.

5. The method of claim 1, wherein in step (d) the notification to the device further includes a request for a response from the device.

6. The method of claim 5 further including the steps of:
(e) receiving a response from the device.

7. The method of claim 6 further including the steps of:
(f) receiving a response from the device; and
(g) removing the notification from the device for the device to close the connection.

8. The method of claim 6 further including the steps of:
(f) receiving a response from the device; and
(g) updating the notification to the device via the connection.

9. The method of claim 6 further including the steps of:
(f) receiving a response from the device; and
(g) sending a new notification to the device via the connection.

10. A method of pushing asynchronous notifications to devices in a network, comprising the steps of:
(a) establishing a connection with one of the devices;
(b) sending a request for data to the device;
(c) receiving a reply from the device;
(d) checking for a notification tag in the reply, and if the reply includes a notification tag, maintaining the connection to the device for notifications; and
(e) receiving a notification for an event from the device via the connection.

11. The method of claim 10 wherein step (c) further includes the steps of receiving the requested data in the reply.

12. The method of claim 10 further including the steps of:
(f) receiving the new data from the device.

13. The method of claim 10 further including the steps of:
(f) receiving the new data from the device via the connection.

14. The method of claim 10 wherein the notification from the device further includes a request for a response.

15. The method of claim 14 further including the steps of:
(g) sending a response to the device.

16. The method of claim 15 further including the steps of:
(h) receiving a notification removal from the device.

17. The method of claim 15 further including the steps of:
(h) receiving an updated notification from the device via the connection.

18. The method of claim 15 further including the steps of:
(h) receiving a new notification from the device via the connection.

19. A method of pushing asynchronous notifications to devices in a network including client devices and server devices, comprising the steps of:
(a) establishing a connection between a client device and a server device;
(b) the client device sending a request for data to the server device;
(c) the server device including a notification tag in a reply to the request from the client device for the client device to maintain the connection to the server device to await notifications from the server device;
(d) the client device receiving the reply from the server device;
(e) the client device checking for a notification tag in the reply, and if the reply includes a notification tag, the client device maintaining the connection to the server device for notifications; and
(f) the server device notifying the client device that an event has occurred.

20. The method of claim 19 wherein step (c) further includes the steps of the server device including data requested by the client device in the reply.

21. The method of claim 19 wherein step (d) further includes the steps of the client device receiving the requested data in the reply from the server device.

22. The method of claim 20 wherein step (d) further includes the steps of the client device displaying the requested data on a display.

23. The method of claim 19 further including the steps of:
(g) the server device sending new data to the client device.

24. The method of claim 23 further including the steps of:
(h) the client device receiving the new data from the server device.

25. The method of claim 19 further including the steps of:
(g) the server device sending new data to the client device via the connection; and
(h) the client device receiving the new data from the server device via the connection.

26. The method of claim 19 wherein in step (f) the notification from the server device further includes a request for a response from the client device.

27. The method of claim 16 further including the steps of:
(g) the client device sending a response to the client device.

28. The method of claim 26 further including the steps of:
(h) the server device receiving the response from the client device;
(i) the server device removing the notification from the client device; and
(j) the client device closing the connection.

29. The method of claim 26 further including the steps of:
(h) the server device receiving the response from the client device; and
(i) the server device updating the notification to the client device via the connection.

30. The method of claim 26 further including the steps of:
(h) the server device receiving the response from the client device; and
(i) the server device sending a new notification to the client device via the connection.

31. A system for pushing asynchronous notifications to electronic devices, comprising:
a client device and a server device, such that a connection can be established between the client device and a server device;
the client device and the server device are configured such that:
the client device sends a request for data to the server device;
upon receiving the request, the server device includes a notification tag in a reply to the request for the client device to maintain the connection to the server device to await notifications from the server device; and
upon receiving the reply, the client device checks for a notification tag in the reply, and if the reply includes a notification tag, the client device maintains the connection to the server device for notifications, such that thereafter the server device can send event notifications to the client device via the connection.

32. The system of claim 31 wherein the server device further includes the data requested by the client device in the reply.

33. The system of claim 31 wherein after sending the notification, the server device further sends new data to the client device.

34. The system of claim 31 the notification from the server device further includes a request for a response from the client device.

35. The system of claim 34 wherein the client device further sends a response to the client device in response to the request from the server device.

36. The system of claim 35 wherein upon receiving the response from the client device, the server device removes the notification from the client device such that the client device closes the connection.

37. The system of claim 35 wherein upon receiving a receiving the response from the client device, the server device updates the notification to the client device via the connection.

38. The system of claim 35 wherein upon receiving the response from the client device, the server device sends a new notification to the client device via the connection.

39. The system of claim 35 wherein upon receiving the response from the client device, the server device selectively performs tasks based on the response.

40. The system of claim 31 wherein the client device and the server device utilize the HTTP protocol.

41. The system of claim 40 wherein the client device includes a Web browser.

42. The system of claim 40 wherein the server device includes a Web browser.

43. The system of claim 40 wherein the server device includes a Web server.
